(19) United States
(12) Patent Application Publication
(10) Pub. No.: US 2004/0055814 A1
(43) Pub. Date: Mar. 25, 2004

(54) Engine noise control system

(76) Inventors: David Jeungsuck Chae, Windsor (CA); Bryan Bestvater, Essex (CA); Jason Pettipiece, Chatham (CA); York Zhu, Windsor (CA)

Correspondence Address: SIEMENS CORPORATION, INTELLECTUAL PROPERTY LAW DEPARTMENT, 170 WOOD AVENUE SOUTH, ISELIN, NJ, 08830, US

(21) Appl. No.: 10/464,014

(22) Filed: Jun. 18, 2003

Related U.S. Application Data
(60) Provisional application No. 60/389,581, filed on Jun. 18, 2002.

(51) Int. Cl. F16F 7/00

(52) U.S. Cl. 181/207

(57) ABSTRACT

An engine noise reduction system includes a spring-biased valve (106) disposed in an engine air inlet (100). When the engine (104) is operating in a first mode that draws an increased amount of air through the inlet (100), vacuum pressure generated by the increased air flow overcomes the biasing force in the spring and forces the valve (106) open, maximizing air flow through the inlet. When the engine (104) operates in a second mode that requires less air, the biasing force overcomes the reduced vacuum pressure in the inlet (100), closing the valve (106) and thereby restricting the amount of air flowing through the inlet (100). The reduced airflow area changes the acoustic impedance for transmitting engine noise through the inlet (100).

### REFERENCE TO RELATED APPLICATIONS

The present invention claims priority to U.S. Provisional Patent Application No. 60/389,581, filed Jun. 18, 2002.

### TECHNICAL FIELD

The present invention relates to noise control systems, and more particularly to a system that controls noise in a valve actuation inlet for an engine.

### BACKGROUND OF THE INVENTION

There are currently engines designed to operate in two or more modes where different numbers of cylinders are fired during each mode. For purposes of illustration only, the example described below addresses an engine having eight cylinders and that operates in two modes, one using all eight cylinders and one using only four out of the eight cylinders. However, the description below is applicable to any engine having any number of cylinders and any number of operating modes with any number of cylinders switched on and off.

During a low power mode, four out of the eight cylinders may be operated, creating an engine sound having predominantly low frequency components. In one embodiment, the signature of the engine noise is predominated by the firing frequency of the engine, which is around twice the engine rotational speed. Typically, the frequency range during this mode is 33 to 170 Hz as the engine runs from idle to 5000 rpm. When the engine mode is operated in a high power mode, where all eight cylinders are operating, the additional cylinders change the engine noise characteristic by increasing the frequency to, typically, four times the engine speed (e.g., around 100 to 400 Hz in the primary engine firing range).

However, currently known noise control systems are not able to adapt their noise control properties to handle the noise characteristic of different engine operating modes. This causes significant noise character changes as the engine mode switches while the noise control system does not follow suit.

There is a desire for a noise reduction system that can reliably control noise in an engine having more than one operating mode generating different noise characteristics.

### SUMMARY OF THE INVENTION

The present invention is directed to an engine noise reduction system comprising a valve disposed in an engine air inlet. The valve is biased by a resilient member in a closed position to restrict the amount of air flowing through the air inlet. When the engine is operating in a first mode that draws an increased amount of air through the inlet, vacuum pressure generated by the increased air flow overcomes the biasing force in the resilient member and forces the valve open, maximizing air flow through the inlet.

When the engine operates in a second mode that requires less air, the reduced air flow reduces the vacuum pressure in the inlet to a level below the biasing force of the resilient member. The biasing force then closes the valve, reducing the amount of air available for transmitting engine noise through the inlet.

As a result, the inventive system can allow the maximum amount of air to reach the engine for a given engine operating mode while minimizing engine noise, particularly low-frequency noise generated during the second mode.

### BRIEF DESCRIPTION OF THE DRAWINGS

FIG. 1 is a representative diagram of a system having a noise control mechanism according to one embodiment of the invention;

FIG. 2 is perspective view of an air inlet having a noise control mechanism according to one embodiment of the invention;

FIG. 3 is a section view of the noise control mechanism during a first engine operating mode; and

FIG. 4 is a section view of the noise control mechanism during a second engine operating mode.

### DETAILED DESCRIPTION OF THE EMBODIMENTS

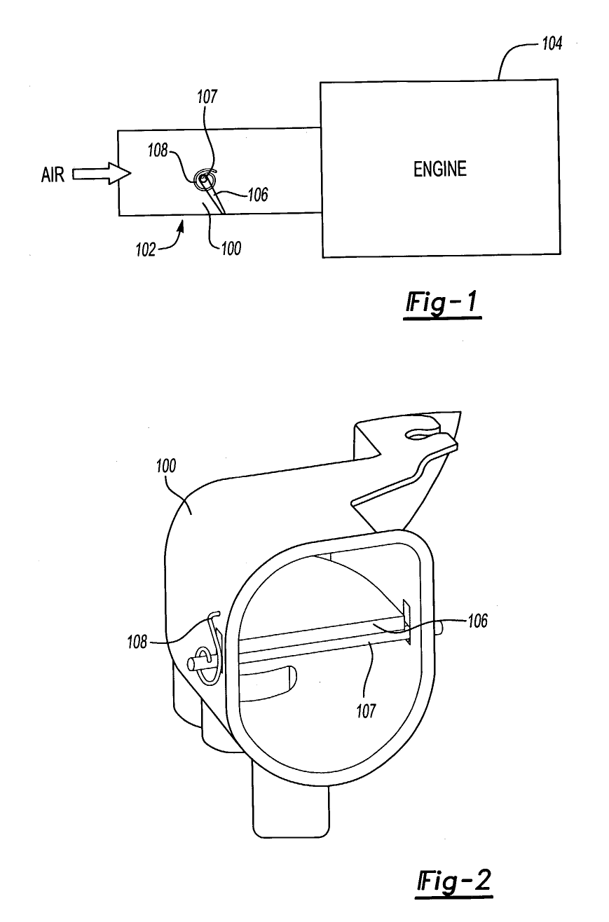

FIG. 1 is a representative diagram illustrating a relationship between an air inlet 100 and a noise control mechanism 102 according to one embodiment of the invention. The air inlet 100 is connected to an engine 104, and the noise control mechanism 102 controls air flow through the inlet as well as the amount of noise exiting the inlet. In one embodiment, the noise control mechanism 102 comprises a valve 106 movably supported within the inlet 100 by a support 107 connected to a resilient member 108, which biases the valve 106 in a first position. The support 107 can be any known support structure, such as a separate support shaft or support protrusions integrally connected to and extending from the valve 106. Further, the resilient member 108 can be any device, such as a coil spring or a leaf spring, that moves the valve 106 in the desired manner. In one embodiment, the valve 106 is positioned so that it closes off approximately half of the air inlet 100 when it is in the first position.

FIG. 2 is a perspective view of the air inlet 100 and the noise control mechanism 102 according to one embodiment of the invention. Generally, the invention attenuates noise by changing acoustic impedance through the inlet 100 based on the operating mode of the engine. The valve 106 is positioned to increase airflow during a first engine operating mode where most or all of the cylinders are operating (e.g., 8 cylinders) and to restrict airflow during a second engine operating mode where fewer of the cylinders are operating (e.g., 4 cylinders).

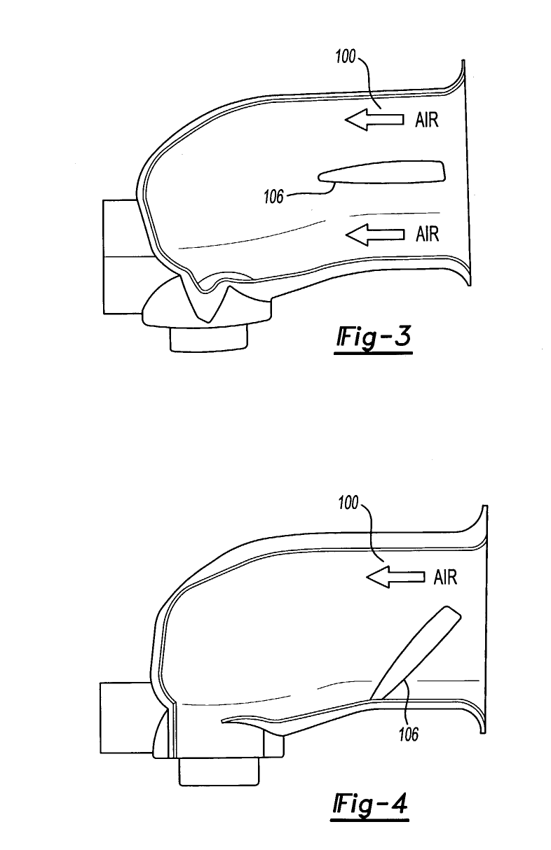

More particularly in this example, when all of the cylinders in the engine 104 are running, the valve 106 moves to an open position (FIG. 3) to maximize the amount of air flowing through the entire air inlet 100, allowing the engine 104 to operate at its maximum power. When the engine 104 switches to the second operating mode, which uses less than all of the cylinders, the valve 106 moves to a closed position (FIG. 4), restricting air flow through the inlet 100 and therefore to the engine 104. Although it is desirable to maximize air flow at all times, this air flow restriction does not adversely affect engine operation because the amount of air required by the engine 104 in the second operating mode is significantly less than in the first mode due to the reduced number of operating cylinders.

The valve 106 rotates about the shaft 107. The resilient member 108 connected to the shaft 107 biases the valve 106 in the closed position in this embodiment. When the engine 104 operates in the first mode with all cylinders firing, the air drawn by the engine 104 and the resulting pressure characteristic within the air inlet 100 overcomes the biasing force in the resilient member 108 and forces the valve 106 to the open position (FIG. 3). In other words, the increased air requirements by the engine 104 when it is operating in the first mode increases the air flow and the vacuum pressure in the inlet 100, forcing the valve 106 open.

When the engine 104 is operating in the second mode, however, the air drawn by the engine 104 is reduced, reducing the air flow and vacuum pressure inside the inlet 100. The biasing force of the resilient member 108 is calibrated so that it will overcome the vacuum pressure in the inlet 100 when the engine 104 is operating in the second mode, forcing the valve 106 to move to the closed position. The actual amount of biasing force in the resilient member 108 can be determined through experimentation via any known method.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A noise control system for an engine having an air inlet and that operates in a first mode and a second mode, comprising:
a valve disposed in the air inlet;
a support that holds the valve in the air inlet; and
a resilient member operably coupled to the valve, wherein the resilient member has a biasing force that biases the valve to a closed position, and wherein the an air pressure characteristic during the second mode overcomes the biasing force to move the valve to an open position.

2. The noise control system of claim 1, wherein the valve is disposed in the air inlet to allow air to flow through approximately half of the air inlet when the valve is in the closed position.

3. The noise control system of claim 1, wherein the support comprises a shaft connected to the valve.

4. The noise control system of claim 1, wherein the support comprises at least one support protrusion integrally formed with the valve.

5. The noise control system of claim 1, wherein the resilient member is one selected from the group consisting of a coil spring and a leaf spring.

6. A noise control system for an engine having an air inlet and a plurality of cylinders, wherein the engine operates fewer than all of the cylinders in a first mode and operates all of the cylinders in a second mode, the noise control system comprising:
a valve disposed in the air inlet and movable between an open position where air is allowed to flow through substantially the entire air inlet and a closed position where air is allowed to flow through a portion of the air inlet;
a support that holds the valve in the air inlet; and
a spring operably coupled to the valve, wherein the spring has a biasing force that biases the valve to a closed position and wherein the air pressure characteristic during the second mode overcomes the biasing force to move the valve to an open position.

7. The noise control system of claim 6, wherein the valve is disposed in the air inlet to allow air to flow through approximately half of the air inlet when the valve is in the closed position.

8. The noise control system of claim 6, wherein the support comprises a shaft connected to the valve.

9. The noise control system of claim 6, wherein the support comprises at least one support protrusion integrally formed with the valve.
